(19) United States
(12) Patent Application Publication
(10) Pub. No.: US 2026/0061413 A1
(43) Pub. Date: Mar. 5, 2026

(54) ANION EXCHANGE POLYMERS CAPABLE OF CONTROLLED CROSSLINKING

(71) Applicants: University of Delaware, Newark, DE (US); Versogen, Inc., Wilmington, DE (US)

(72) Inventors: Yushan Yan, Hockessin, DE (US); Lan Wang, Newark, DE (US); Hui Duan, Newark, DE (US); Junhua Wang, Hockessin, DE (US); Keda Hu, Newark, DE (US)

(21) Appl. No.: 19/236,748

(22) Filed: Jun. 12, 2025

Related U.S. Application Data
(60) Provisional application No. 63/660,459, filed on Jun. 14, 2024.

(51) Int. Cl. B01J 41/13; C08G 73/06; H01M 8/1004

(52) U.S. Cl. CPC B01J 41/13; C08G 73/0688; H01M 8/1004

(57) ABSTRACT

Polymers based on poly(aryl alkylene) that are capable of crosslinking in a controlled manner are provided. Crosslinked anion exchange membranes or anion exchange ionomers formed from these polymers not only have superior chemical stability and hydroxide conductivity but also have decreased water uptake and improved mechanical stability.

### CROSS REFERENCE TO RELATED APPLICATIONS

This application claims the benefit of U.S. Patent Application No. 63/660,459 filed Jun. 14, 2024, which is herein incorporated by reference in its entirety.

### GOVERNMENT LICENSE RIGHTS

This invention was partly made with Government support under grant W911NF-23-2-0028 awarded by the United States Department of Defense. The Government has certain rights in the invention.

### FIELD OF THE INVENTION

Anion exchange polymers capable of forming crosslinking anion-exchange membranes (AEMs) and ionomers (AEls) are provided for use in anion exchange membrane electrochemical devices such as anion exchange membrane fuel cells (AEMFCs) and anion exchange membrane electrolyzers (AEMELs).

### BACKGROUND OF THE INVENTION

AEMFCs are considered to be clean and efficient power sources, and AEMELs are recognized for their potential to produce green hydrogen at scale and at a lower cost compared to other electrolysis technologies. Both AEMFCs and AEMELs are equipped with AEMs, able to work with non-precious metal catalysts and less expensive components. Varcoe, et al., Fuel Cells 2005, 5, 187; Gu et al., Angew Chem Int Edit 2009, 48, 6499; Gu et al., Chem Commun, 2013, 49, 131.

One of the major challenges of AEMFCs and AEMELs is the low mechanical robustness of AEM and membrane electrode assembly (MEA) that consists of a mixture of a catalyst and an ionomer. An AEM or a MEA with poor mechanical integrity often leads to pre-mature failure of the electrochemical devices as a result of pinholes, tearing of the membrane, and wash out of catalysts and ionomers due to water erosion, gas evolution or polymer dissolution during operation and dry-wet cycles.

One of the strategies to improve the membranes and MEA mechanical integrity is chemical crosslinking. Gu et al., Chem Comm. 2011, 47, 2 856; Park et al., Electrochem Solid St 2012, 15, B27; Wang et al., Chemsuschem 2015, 8, 4229; Ran et al., Sci Rep-Uk 2014, 4; Tanaka et al., J Am Chem Soc 2011, 133, 10646. Crosslinking enhances the mechanical and dimensional stability of anion exchange membranes (AEM) and membrane electrode assemblies (MEA). By forming covalent chemical bonds between polymer chains, crosslinking creates a relatively rigid and strong polymer network. This network structure helps to prevent excessive water uptake and swelling, especially under conditions of high temperature and humidity, and it thus contributes to morphological stability, stable electrochemical performance, and enhanced longevity.

Conventional crosslinking methods rely on the use of crosslinking reagents at relatively high concentrations. One major drawback of these methods is the limited choice of polymers, as not all polymers are compatible with the crosslinking reagents or the conditions required for crosslinking. Moreover, the presence of unreacted crosslinking reagents increases the risk of potential contamination issues, resulting in undesired membrane properties. Alternative crosslinking strategies that can minimize the use of crosslinking reagents to provide more control over the crosslinking are highly desired.

### SUMMARY OF THE INVENTION

The first aspect of the invention is directed to a crosslinkable anion exchange polymer which comprises structural units of formulae 1A, 1A-2, 3A, optionally 2A and optionally 6A. A sum of mole fractions of the structural units of formulae 1A, 1A-2, 2A and 6A is equal to a sum of a mole fraction of formulae 3A in the polymer calculated from an amount of monomers used in a polymerization reaction to form the polymer, and a mole ratio of the structural unit of Formula 1A or 1A-2 or 2A or 6A to the structural unit of Formula 3A is from 0.01 to 1 calculated from the amount of monomers used in the polymerization reaction. The structural units of Formulae 1A, 1A-2, 2A, 3A, and 6A have the structures:

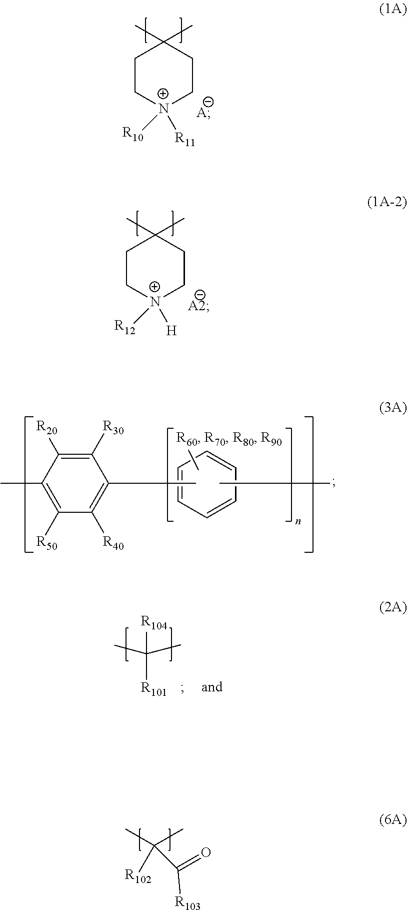

wherein:
A⁻ and A₂⁻ are each independently an anion;
L is Cl, Br or I;
n are each independently 0, 1, 2 or 3;
q is 0, 1, 2, 3, 4, 5 or 6;
R₁₀ and R₁₂ are each independently, alkyl, alkenyl, alkynyl or aryl;
R₁₁ is each independently halide substituted alkyl, alkenyl, alkynyl, aryl, or 5A having structure:

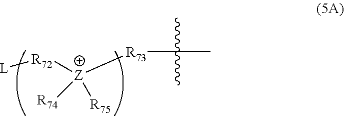

R₂₀, R₂₁, R₂₂, R₂₃, R₂₄, R₂₅, R₂₆, R₂₇, R₂₈, R₂₉, R₃₀, R₄₀, R₅₀, R₆₀, Ro, R₈₀, R₉₀, and R₁₀₄ are each independently hydrogen, halide, alkyl, alkenyl, alkynyl or aryl, and the alkyl, alkenyl, alkynyl or aryl are optionally substituted with halide; wherein R₃₀ and R₆₀ are optionally linked to form a five membered ring optionally substituted with halide or alkyl;
R₇₂, R₇₃, R₇₄ and R₇₅ are each independently alkyl, alkenyl, alkynyl or aryl;
each R₁₀₁ is independently 2B or 3B having structure:

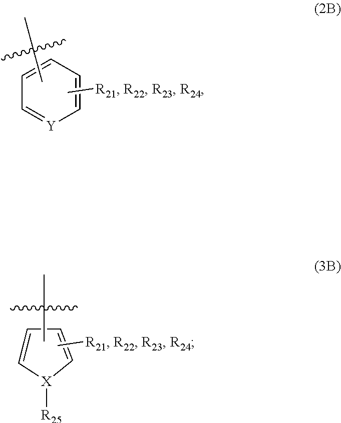

R₁₀₂ and R₁₀₃ are each independently alkyl, alkenyl, alkynyl, amine or aryl, and the alkyl, alkenyl, alkynyl, amine or aryl are optionally substituted with halide or alkyl, and wherein R₁₀₂ and R₁₀₃ are optionally linked to form a five or six membered ring or a polycycle;
X is N, S or O;
Y is C or N; and
Z is N or P.

The second aspect of the invention is directed to a crosslinkable anion exchange polymer which comprises structural units of formulae 1A, 1A-2, 3A, 4A, optionally 2A and optionally 6A. A sum of mole fractions of the structural units of formulae 1A, 1A-2, 2A, 4A and 6A is equal to a sum of a mole fraction of formula 3A in the polymer calculated from an amount of monomers used in a polymerization reaction to form the polymer, and a mole ratio of the structural unit of Formula 1A or 1A-2 or 2A or 4A or 6A to the structural unit of Formula 3A is from 0.01 to 1 calculated from the amount of monomers used in the polymerization reaction. The structural units of Formulae 1A, 1A-2, 2A, 3A, and 6A are as defined above for the first aspect, and the structural unit of formula 4A has the structure

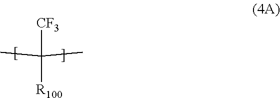

wherein:
R₁₀₀ is each independently alkyl, alkenyl, alkynyl, or

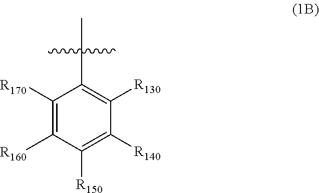

and the alkyl, alkenyl, or alkynyl are optionally substituted with fluoride; and
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide.

A third aspect of the invention is directed to an anion exchange polymer which comprises a reaction product of a mixture comprising an acid, a reagent having formula 5 and a polymer comprising structural units of formulae 1, 3A, optionally 1A-3, optionally 2A, and optionally 6A. A sum of mole fractions of the structural units of formulae 1, 2A, 1A-3 and 6A is equal to a sum of a mole fraction of formula 3A in the polymer calculated from an amount of monomers used in a polymerization reaction to form the polymer, and a mole ratio of the structural unit of Formula 1 or 1A-3 or 2A or 6A to the structural unit of Formula 3A is from 0.01 to 1 calculated from the amount of monomers used in the polymerization reaction, and a mole ratio of the acid or reagent of formula 5 to the structural unit of formula 1 in the polymer is from 0.01 to 0.99. The structural units of Formulae 1, 1A-3, 2A, 3A, 5 and 6A have the structures:

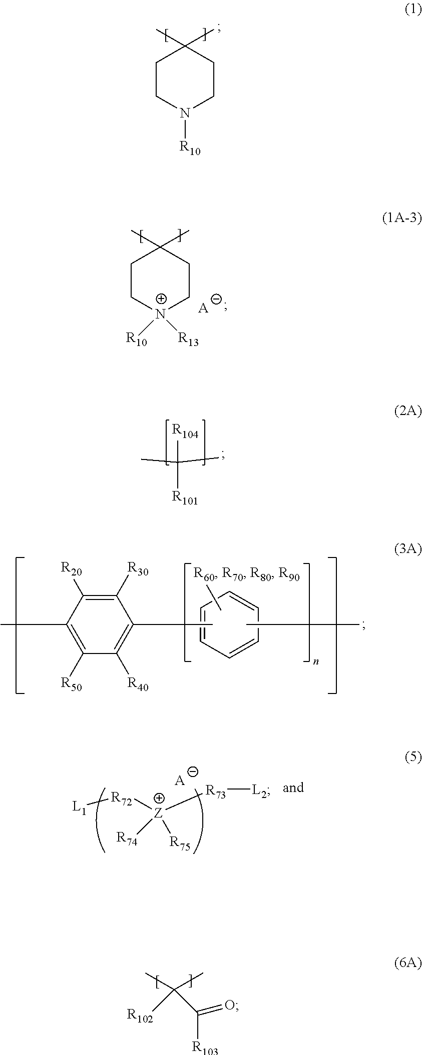

wherein:
A⁻ is an anion;
n are each independently 0, 1, 2 or 3;
q is 0, 1, 2, 3, 4, 5 or 6;
L₁ and L₂ are each independently Cl, Br, I, a tosylate, a mesylate, or a triflate;
R₁₀ is independently alkyl, alkenyl, alkynyl or aryl;
R₁₃ is independently hydrogen, alkyl, alkenyl, alkynyl or aryl;
R₂₀, R₂₁, R₂₂, R₂₃, R₂₄, R₂₅, R₂₆, R₂₇, R₂₈, R₂₉, R₃₀, R₄₀, R₅₀, R₆₀, R₇₀, R₈₀, R₉₀, and R₁₀₄, are each independently hydrogen, halide, alkyl, alkenyl, alkynyl or aryl, and the alkyl, alkenyl, alkynyl or aryl are optionally substituted with halide; wherein R₃₀ and R₆₀ are optionally linked to form a five membered ring optionally substituted with halide or alkyl;
R₇₂, R₇₃, R₇₄ and R₇₅ are each independently alkyl, alkenyl, alkynyl or aryl;
each R₁₀₁ is independently 2B or 3B having structure:

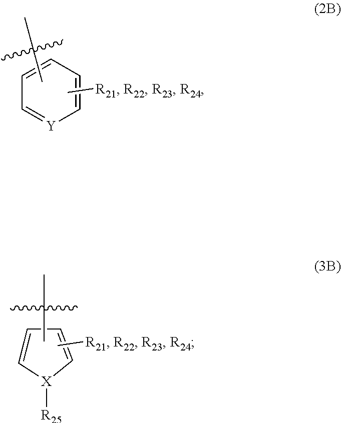

R₁₀₂ and R₁₀₃ are each independently alkyl, alkenyl, alkynyl, amine or aryl, and the alkyl, alkenyl, alkynyl, amine or aryl are optionally substituted with halide or alkyl, and wherein R₁₀₂ and R₁₀₃ are optionally linked to form a five or six membered ring or a polycycle;
X is N, S or O;
Y is C or N; and
Z is N or P.

The fourth aspect of the invention is directed to an anion exchange polymer which comprises a reaction product of a mixture comprising an acid, a reagent having formula 5 and a polymer comprising structural units of formulae 1, 3A, 4A, optionally 1A-3, optionally 2A, and optionally 6A. A sum of mole fractions of the structural units of formulae 1, 1A-3, 2A, 4A and 6A is equal to a sum of a mole fraction of formula 3A in the polymer calculated from an amount of monomers used in a polymerization reaction to form the polymer, and a mole ratio of the structural unit of Formula 1 or 1A-3 or 2A or 4A or 6A to the structural unit of Formula 3A is from 0.01 to 1 calculated from the amount of monomers used in the polymerization reaction, and a mole ratio of the acid or reagent of formula 5 to the structural unit of formula 1 in the polymer is from 0.01 to 0.99. The structural units of Formulae 1, 1A-3, 2A, 3A, 5 and 6A are as defined above for the third aspect, and the structural unit of formula 4A has the structure

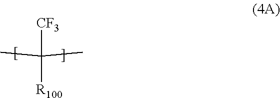

wherein:
each R₁₀₀ is independently alkyl, alkenyl, alkynyl, or 1B having structure:

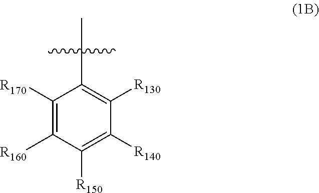

and the alkyl, alkenyl, or alkynyl are optionally substituted with fluoride; and
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide.

A method of making a crosslinked anion exchange polymer is provided. The method comprises: reacting a reagent of formula 5, optionally an acid, and a polymer comprising structural units of formulae 1, 3A, optionally 1A-3, optionally 2A and optionally 6A or structural units of formulae 1, 3A, 4A, optionally 1A-3, optionally 2A and optionally 6A to form the crosslinkable polymer of the first or second aspect of the invention; precipitating the crosslinkable polymer; rinsing and drying the crosslinkable polymer; mixing the crosslinkable polymer and a base capable of initiating crosslinking while controlling reaction temperature and reaction time to obtain a crosslinked polymer having a desired degree of crosslinking such as from about 1 to 100% crosslinking; and optionally exchanging anions of the crosslinked polymer with hydroxide, bicarbonate, or carbonate ions or a combination thereof to form a crosslinked anion exchange polymer.

A method of making a crosslinked anion exchange membrane is also provided. The method comprises: reacting a reagent of formula 5, optionally an acid, and a polymer comprising structural units of formulae 1, 3A, optionally 1A-3, optionally 2A and optionally 6A or structural units of formulae 1, 3A, 4A, optionally 1A-3, optionally 2A and optionally 6A to form the crosslinkable polymer of the first or second aspect of the invention; precipitating the crosslinkable polymer; rinsing and drying the crosslinkable polymer; dissolving the crosslinkable polymer in a solvent to form a polymer solution; casting a crosslinkable membrane from the polymer solution; mixing the crosslinkable membrane and a base capable of initiating crosslinking while controlling reaction temperature and reaction time to obtain a crosslinked membrane having a desired degree of crosslinking such as from about 1 to 100% crosslinking; and optionally exchanging anions of the crosslinked membrane with hydroxide, bicarbonate, or carbonate ions or a combination thereof to form a crosslinked anion exchange membrane.

A method of making a membrane electrode assembly (MEA) with crosslinked ionomer is provided. The method comprises: reacting a reagent of formula 5, optionally an acid, and a polymer comprising structural units of formulae 1, 3A, optionally 1A-3, optionally 2A and optionally 6A or structural units of formulae 1, 3A, 4A, optionally 1A-3, optionally 2A and optionally 6A to form the crosslinkable polymer of the first or second aspect of the invention; precipitating the crosslinkable polymer; rinsing and drying the crosslinkable polymer; dissolving the crosslinkable polymer in a solvent to form a polymer suspension; mixing the polymer suspension with a catalyst to form a catalyst ink; applying the catalyst ink to a membrane to form a MEA; drying the MEA; mixing the MEA and a base capable of initiating crosslinking while controlling reaction temperature and reaction time to obtain a crosslinked membrane having about 1 to 100% crosslinking; and optionally exchanging anions of the crosslinked MEA with hydroxide, bicarbonate, or carbonate ions or a combination thereof to form the MEA with crosslinked ionomer.

A crosslinked anion exchange membrane is also provided, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO2 separator, and the anion exchange membrane comprising any of the anion exchange polymers as described above.

A crosslinked anion exchange membrane fuel cell, electrolyzer, electrodialyzer, solar hydrogen generator, flow battery, desalinator, sensor, demineralizer, water purifier, waste water treatment system, ion exchanger, or CO2 separator is also provided, the fuel cell, electrolyzer, electrodialyzer, solar hydrogen generator, flow battery, desalinator, sensor, demineralizer, water purifier, waste water treatment system, ion exchanger, or CO2 separator is provided, comprising any of the anion exchange polymers as described above.

Also provided is a reinforced ion exchange or electrolyte membrane, optionally configured and sized to be suitable for use in a fuel cell, electrolyzer, electrodialyzer, solar hydrogen generator, flow battery, desalinator, sensor, demineralizer, water purifier, waste treatment system, ion exchanger, or CO2 separator. The membrane comprises a porous substrate impregnated with any of the anion exchange polymers as described above.

Other objects and features will be in part apparent and in part pointed out hereinafter.

### BRIEF DESCRIPTION OF THE DRAWINGS

FIG. 1A illustrates an exemplary anion exchange membrane or hydroxide exchange membrane fuel cell;

FIG. 1B illustrates an exemplary anion exchange membrane or hydroxide exchange membrane electrolyzer;

FIG. 2 depicts a 1HNMR spectrum of TP-1-CI-0.8 in DMSO-d6;

FIG. 3 depicts how the crosslinked membrane swells in DMSO; and

FIG. 4 is a graph of water uptake percentage in DI water as a function of temperature from 20° C. to 80° C. for crosslinked and non-crosslinked membranes.

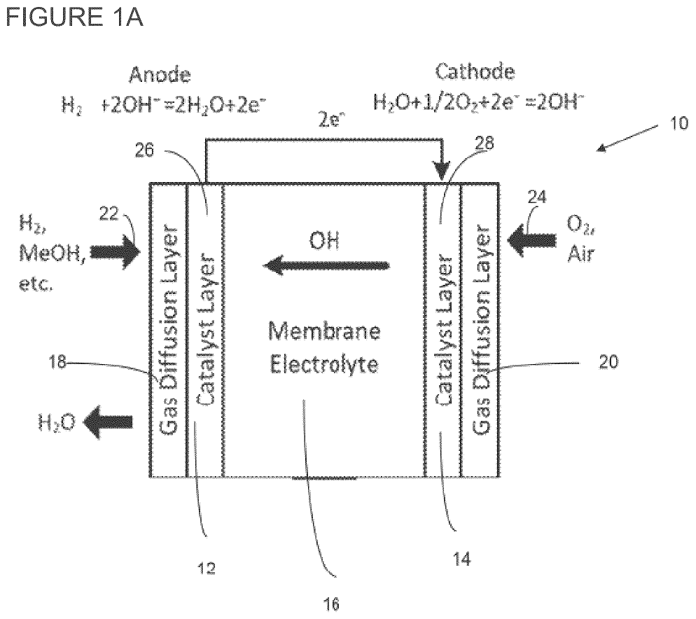

### DESCRIPTION OF THE PREFERRED EMBODIMENTS

Herein, a series of anion exchange polymers were prepared, and the membranes and MEA were crosslinked under a controlled manner in that the crosslinking was triggered simply by introduction of an alkaline solution to the polymer without addition of a crosslinking reagent. Crosslinked AEMs/AEIs showed reduced swelling, water uptake and increased conductivity.

AEMs/AEIs formed from poly(aryl alkylene) polymers with various pendant piperidinium-functionalized groups and having intrinsic hydroxide conduction channels have been discovered which simultaneously provide improved chemical stability, conductivity, water uptake, good solubility in selected solvents, mechanical properties, and other attributes relevant to HEM/HEI performance. The inventive polymers and membranes are capable of crosslinking in an alkaline solution or suspension to form crosslinked polymers and membranes that further enhance their conductivity, water uptake, mechanical stability at relatively high temperatures.

The first through fourth aspects of the invention are described in the summary above.

In the first aspect, the polymer can comprise the structural units of formulae 1A, 1A-2 and 3A; or 1A, 1A-2, 3A and 2A; or 1A, 1A-2, 3A and 6A; or 1A, 1A-2, 3A, 2A and 6A.

In the second aspect, the polymer can comprise the structural units of formulae 1A, 1A-2, 3A and 4A; or 1A, 1A-2, 3A, 4A and 2A; or 1A, 1A-2, 3A, 4A and 6A; or 1A, 1A-2, 3A, 4A, 2A and 6A.

In the first aspect of the invention, the mole ratio of a sum of the mole fractions of the structural unit of Formulae 1A, 1A-2, 2A and 6A to a sum of the mole fraction of Formula 3A in the polymer can be from about 0.85:1 to about 1.4:1, and the ratio of the mole fraction of the structural unit of Formula 1A to the mole fraction of the structural unit of Formula 3A can be from about 0.01 to 0.99. Alternatively, the mole ratio of a sum of the mole fractions of the structural unit of Formulae 1A, 1A-2, 2A and 6A to the mole fraction of Formulae 3A in the polymer can be from about 1:1 to about 1.2:1.

In the second aspect of the invention, the mole ratio of a sum of the mole fractions of the structural unit of Formulae 1A, 1A-2, 2A, 4A and 6A to the mole fraction of Formula 3A in the polymer can be from about 0.85:1 to about 1.4:1, and the ratio of the mole fraction of the structural unit of Formula 1A to the mole fraction of the structural unit of Formula 3A can be from about 0.01 to 0.99. Alternatively, the mole ratio of a sum of the mole fractions of the structural unit of Formulae 1A, 1A-2, 2A, 4A and 6A to the mole fraction of Formulae 3A in the polymer can be from about 1:1 to about 1.2:1.

Regarding the polymer in the reaction mixture in the third aspect of the invention, the mole ratio of a sum of the mole fractions of the structural unit of Formulae 1, 1A-3, 2A and 6A to a sum of the mole fraction of Formula 3A in the polymer can be from about 0.85:1 to about 1.4:1, and the ratio of the mole fraction of the structural unit of Formula 1A to the mole fraction of the structural unit of Formula 3A can be from about 0.01 to 0.99. Alternatively, the mole ratio of a sum of the mole fractions of the structural unit of Formulae 1, 1A-3, 2A and 6A to the mole fraction of Formula 3A in the polymer can be from about 1:1 to about 1.2:1.

Regarding the polymer in the fourth aspect of the invention, the mole ratio of a sum of the mole fractions of the structural unit of Formulae 1, 1A-3, 2A, 4A and 6A to the mole fraction of Formulae 3A in the polymer can be from about 0.85:1 to about 1.4:1, and the ratio of the mole fraction of the structural unit of Formula 1A to the mole fraction of the structural unit of Formula 3A can be from about 0.01 to 0.99. Alternatively, the mole ratio of a sum of the mole fractions of the structural unit of Formula 1, 1A-3, 2A, 4A and 6A to the mole fraction of Formulae 3A in the polymer can be from about 1:1 to about 1.2:1.

R₁₁ of the structural unit of formula 1A of any anion exchange polymers described herein can comprise halide substituted alkyl, alkenyl, alkynyl, aryl, or 5A having structure:

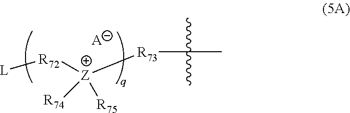

Preferably, in the compound of formula 5A, R₇₃ is independently C₁-C₂₂ alkylene; R₇₂, R₇₄ and R₇₅ are each independently C₁-C₆ alkyl; q is 0, 1, 2, 3, 4, 5, or 6; Z is N or P; L is Cl, Br or I; and A⁻ is an anion.

Alternatively, in the compound of formula 5A, R₇₃ is independently C₁-C₆ alkylene; R₇₂, R₇₄ and R₇₅ are each independently C₁-C₆ alkyl; q is 0, 1, 2, 3, 4, 5, or 6; Z is N; L is Cl, Br or I; and A⁻ is an anion.

For example, formula 5A can have the structure:

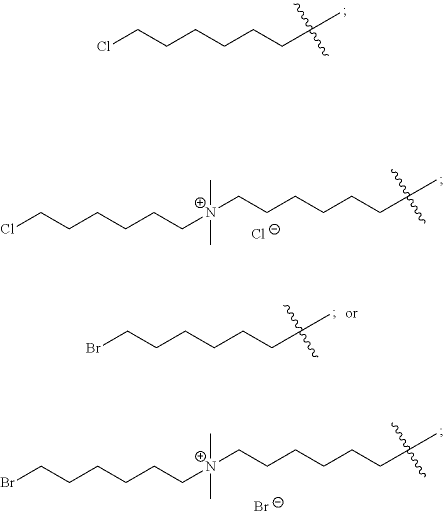 [SMILES: *CCCCCCCl ; *CCCCCC[N+](C)(C)CCCCCCCl ; [Cl-] ; *CCCCCCBr ; *CCCCCC[N+](C)(C)CCCCCCBr ; [Br-]]

or a combination thereof.

R₁₀ and R₁₂ of the structural unit of formulae 1A, 1, 1A-3 and 1A-2 of any of the anion exchange polymers described herein can comprise alkyl, alkenyl, alkynyl or aryl.

R₁₀ and R₁₂ can be each independently C₁-C₂₂ alkylene and preferably, R₁₀ and R₁₂ is each independently C₁-C₆ alkylene.

The structural unit of formula 2A can be:

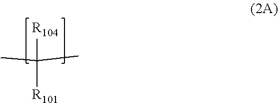

wherein: each R₁₀₁ is independently

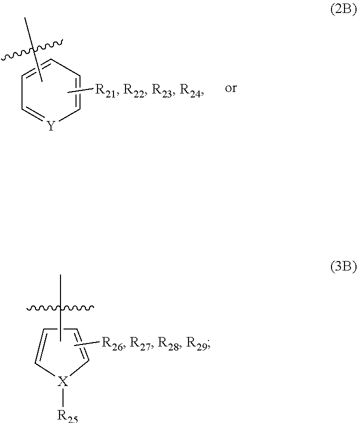

R₂₁, R₂₂, R₂₃, R₂₄, R₂₅, R₂₆, R₂₇, R₂₈, and R₂₉ are each independently hydrogen, halide, alkyl, alkenyl, alkynyl or aryl, and the alkyl, alkenyl, alkynyl or aryl are optionally substituted with halide; R₁₀₄ is hydrogen, halide, alkyl, alkenyl, alkynyl or aryl, and the alkyl, alkenyl, alkynyl or aryl are optionally substituted with halide; X is N, S or O; and Y is C or N. Preferably, R₁₀₄ is alkyl such as methyl, ethyl, propyl, butyl, pentyl, or hexyl; Y is N; X is N, S or O; and R₂₁, R₂₂, R₂₃, R₂₄, R₂₅, R₂₆, R₂₇, R₂₈, R₂₉ and R₁₀₁ are each hydrogen.

The structural unit of formula 3A can be:

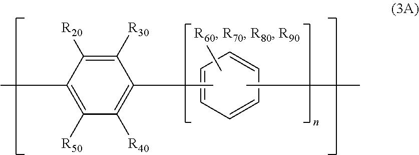

wherein R₂₀, R₃₀, R₄₀, R₅₀, R₆₀, R₇₀, R₈₀, and Roo are each independently hydrogen, halide, alkyl, alkenyl, alkynyl or aryl, and the alkyl, alkenyl, alkynyl or aryl are optionally substituted with halide, and wherein R₃₀ and R₆₀ are optionally linked to form a five membered ring optionally substituted with halide or alkyl; and n is 0, 1, 2 or 3. Preferably, R₂₀, R₃₀, R₄₀, R₅₀, R₆₀, R₇₀, R₈₀, and R₉₀ are each independently hydrogen, or alkyl optionally substituted with fluoride, such as methyl, ethyl, propyl, butyl, pentyl or hexyl or methyl, ethyl, propyl, butyl, pentyl, or hexyl substituted with fluoride.

The structural unit of formula 3A can comprise, for example, any of the following structures:

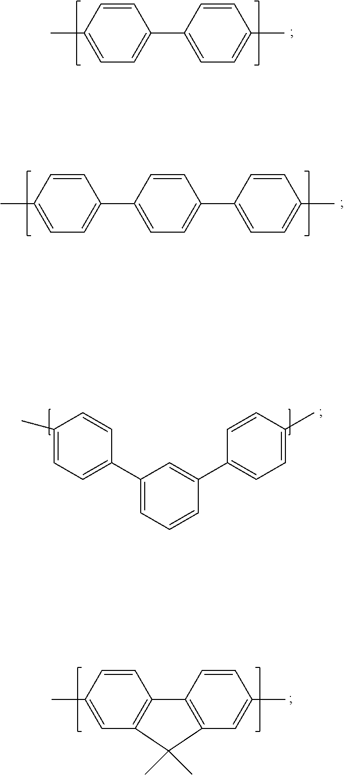

or any combination thereof.

The structural unit of formula 4A can be:

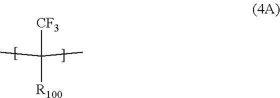

wherein each R₁₀₀ is independently alkyl, alkenyl, alkynyl, or

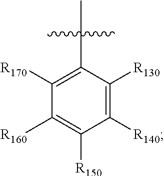

and
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide. Preferably, R₁₃₀, R₁₄₀, R₁₅₀, R₁₆₀ and R₁₇₀ are each independently hydrogen or alkyl optionally substituted with fluoride, such as methyl, ethyl, propyl, butyl, pentyl, or hexyl substituted with fluoride.

The structural unit of formula 6A can be:

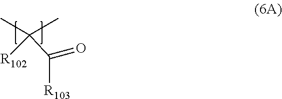

wherein R₁₀₂ and R₁₀₃ are each independently alkyl, alkenyl, alkynyl, amine or aryl, and the alkyl, alkenyl, alkynyl, amine or aryl are optionally substituted with halide or alkyl, and wherein R₁₀₂ and R₁₀₃ are optionally linked to form a five or six membered ring or a polycycle.

The polycycle can have two or more hydrocarbon rings which can be substituted with heteroatoms such as nitrogen or oxygen.

The polycycle can be aromatic or non-aromatic.

Preferably, the structural unit of formula 6A is derived from isatin, 5-bromoisatin, 5-methylisatin, 5-nitroisatin, acenaphthenequinone, benzil or 9,10-phenanthrenequinone. For example, the structural units of formula 6A can be:

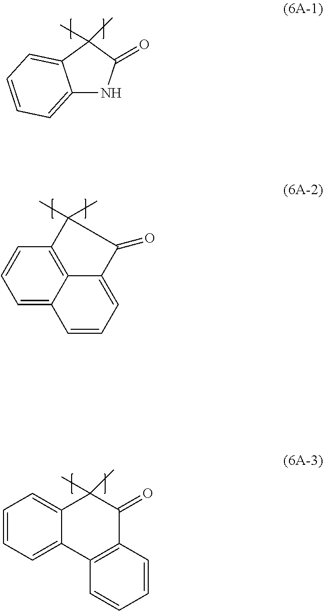

or any combination thereof.

The anion A⁻ and A₂⁻ of the structural units 1A, 1A-2, 1A-3 or 5A can comprise a halide, carbonate, bicarbonate, hydroxide, trifluoroacetate, acetate, triflate, methanesulfonate, sulfate, nitrate, tetrafluoroborate, hexafluorophosphate, formate, benzenesulfonate, toluate, perchlorate, benzoate or any combination thereof.

The acid used in the third and fourth aspects of the invention can comprise hydrochloric acid, hydrobromic acid, hydriodic acid, sulfuric acid, nitric acid, trifluoracetic acid, acetic acid, butyric acid, formic acid, trifluoromethanesulfonic acid or any combination thereof.

Preferably, the acid used in the third and fourth aspects of the invention is hydrochloric acid, hydrobromic acid, hydriodic acid, sulfuric acid, nitric acid, trifluoracetic acid or any combination thereof.

Reagent 5 used in the third and fourth aspects of the invention has structure:

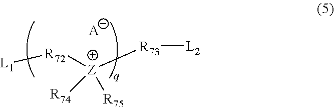

wherein R₇₃ is independently C₁-C₂₂ alkylene; R₇₂, R₇₄ and R₇₅ are each independently C₁-C₆ alkyl; q is 0, 1, 2, 3, 4, 5, or 6; Z is N or P; L₁ and L₂ are each independently Cl, Br, I, a tosylate, a mesylate, or a triflate; and A″ is an anion.

Preferably, in the reagent of formula 5, R₇₃ is independently C₁-C₆ alkylene; R₇₂, R₇₄ and R₇₅ are each independently C₁-C₆ alkyl; q is 0, 1, 2, 3, 4, 5, or 6; Z is N; L₁ and L₂ are each independently Cl, Br or I; and A⁻ is an anion.

Reagent of formula 5 used in the third and fourth aspects of the invention can comprise 1-Bromo-6-chlorohexane, 1-chloro-6-iodoohexane, 1-bromo-6-iodoohexane, 1-Bromo-4-chlorobutane, 1-Chloro-4-iodobutane, 1-Bromo-4-chlorobutane, 1-Bromo-3-chloropropane, 1-Chloro-3-iodopropane, 1-Bromo-3-iodopropane, or any combination thereof. Preferably, reagent of formula 5 is 1-Bromo-6-chlorohexane, 1-chloro-6-iodoohexane, 1-bromo-6-iodoohexane, 1-Bromo-4-chlorobutane, 1-Chloro-4-iodobutane, or 1-Bromo-4-chlorobutane.

The methods of making the polymers, membranes, and MEAs are described in the summary above.

The temperature for the crosslinking reaction in the methods described above can range from 0° C. to 100° C.

The crosslinking reaction time in the methods described above can range from 0.1 h to 100 h.

One of ordinary skill in the art would know how to vary the temperature and reaction time to obtain a desired degree of crosslinking using the methods as described herein.

Using any of the methods described herein, the crosslinked polymer, the crosslinked membrane or the crosslinked MEA can have about 1% to about 100%, about 1% to about 90%, about 1% to about 80%, about 2% to about 75%, about 2% to about 60%, about 3% to about 50%, about 4% to about 40%, about 5% to about 35%, about 5% to about 30%, about 5% to about 25%, about 5% to about 20% or about 5% to about 15% crosslinking.

The base used to crosslink the polymer, ionomer in the MEA or membrane described in the methods above can be KOH, NaOH, NaHCO₃, KHCO3, Na2CO3, K2CO3 or any combination of thereof.

A crosslinked anion exchange membrane is also provided, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator, and the anion exchange membrane comprising any of the anion exchange polymers as described above.

A crosslinked anion exchange membrane fuel cell, electrolyzer, electrodialyzer, solar hydrogen generator, flow battery, desalinator, sensor, demineralizer, water purifier, waste water treatment system, ion exchanger, or CO₂ separator is also provided, the fuel cell, electrolyzer, electrodialyzer, solar hydrogen generator, flow battery, desalinator, sensor, demineralizer, water purifier, waste water treatment system, ion exchanger, or CO₂ separator is provided, comprising any of the anion exchange polymers as described above.

Also provided is a reinforced and crosslinked electrolyte membrane, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator. The membrane comprises a porous substrate impregnated with any of the crosslinked anion exchange polymers as described above.

An anion exchange membrane, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO2 separator, and comprising any of the anion exchange polymers as described herein is provided.

A reinforced electrolyte membrane such as a reinforced anion exchange membrane is also provided to increase the mechanical robustness of the anion exchange membrane for stability through numerous wet and dry cycles. The reinforced membrane comprises a porous substrate impregnated with any of the anion exchange polymers as described herein. Methods for preparing reinforced membranes are well known to those of ordinary skill in the art such as those disclosed in U.S. Pat. Nos. RE37,656 and RE37,701, which are incorporated herein by reference for their description of reinforced membrane synthesis and materials.

A reinforced ion exchange membrane including any polymer membrane of the invention can be optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO2 separator.

The porous substrate of the reinforced electrolyte membrane can comprise a polytetrafluoroethylene, polypropylene, polyethylene, poly(ether) ketone, polyaryletherketone, imidazole-tethered poly(aryl alkylene), imidazolium-tethered poly(aryl alkylene), polysulfone, perfluoroalkoxyalkane, or a fluorinated ethylene propylene polymer, and the membrane is optionally a dimensionally stable membrane.

The porous substrate of the reinforced electrolyte membrane can have at least one of the following:
the porous substrate has a porous microstructure of polymeric fibrils;
an interior volume of the porous substrate is rendered substantially occlusive by impregnation with the polymer;
the porous substrate comprises a microstructure of nodes interconnected by fibrils;
the porous substrate has a thickness from about 1 micron to about 100 microns;
the membrane is prepared by multiple impregnations of the substrate with the polymer; or the membrane is prepared by: wetting the porous substrate in a liquid to form a wetted substrate; dissolving the polymer in a solvent to form a homogeneous solution or suspension;
applying the solution or suspension onto the wetted substrate to form the reinforced membrane; and drying the membrane.

The porous substrate can have a thickness from about 1 micron to about 10, 15, 20, 25, 30, 35, 40, 45, 50, 55, 60, 65, 70, 75, 80, 85, 90, 95 or 100 microns. Preferably, the porous substrate has a thickness from about 5 microns to about 30 microns, or from about 7 microns to about 20 microns.

### EXAMPLES

The following non-limiting examples are provided to further illustrate the present invention. In the reaction schemes in the examples, the symbol [symbol] in any of the crosslinked polymer structures indicates that the depicted structural unit is crosslinked to another such structural unit not shown in the reaction scheme. For example, in scheme 1, TP-n-XL-y includes such a crosslinked structural unit shown as follows:

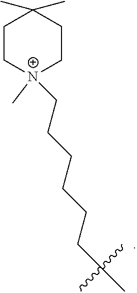

### Example 1

A crosslinkable polymer TP-n-CI-m and its crosslinked form was prepared from TP-n-Neu polymer (N is from 10 to 10000; n is from 0.1 to 1; m is from 0.1 to 1; x is from 0.1 to 1; y is from 0.1 to 1, z is from 0.01 to 0.1) was depicted in scheme 1. As an example, detailed synthesis of TP-1-CI-0.8 (n=1, m=0.8) and its crosslinking procedure was described below.

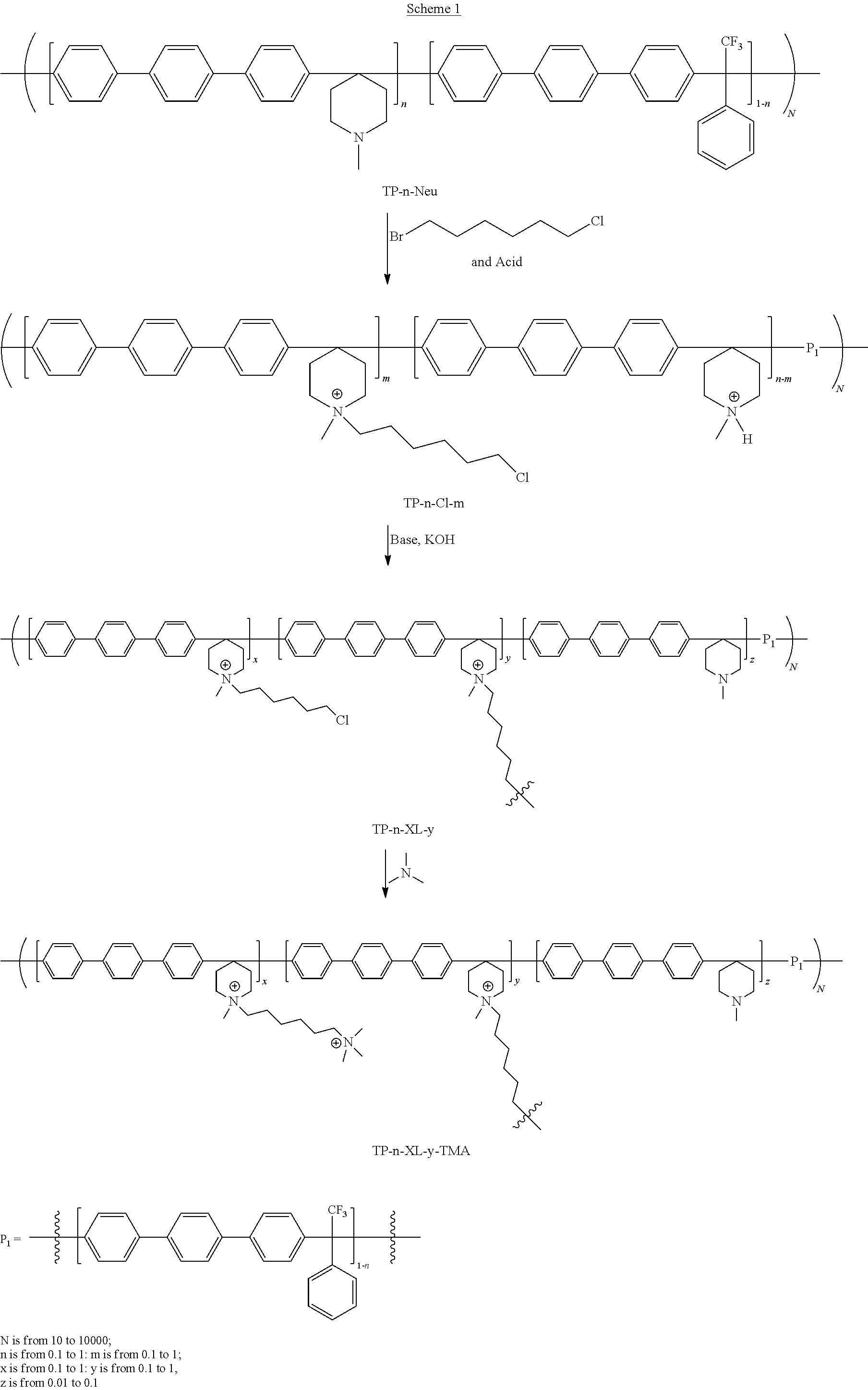

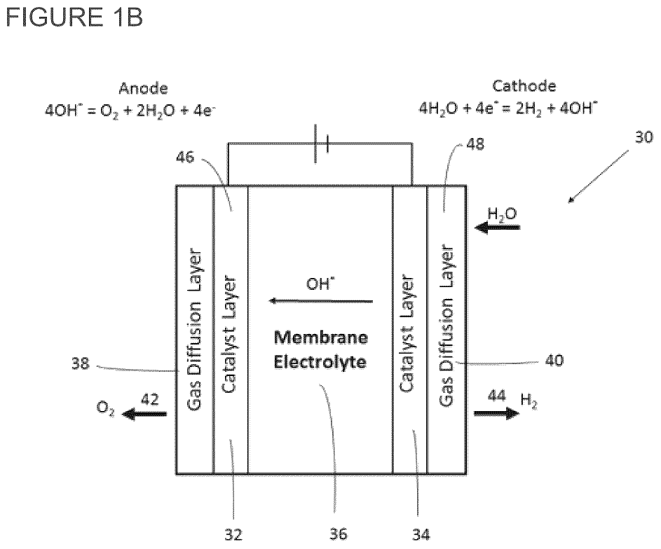

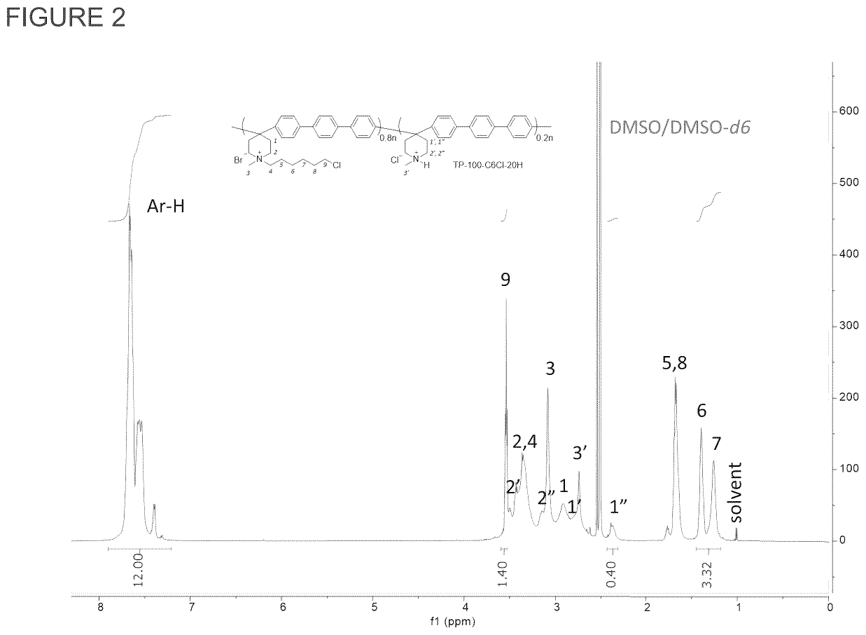

(1) Synthesis of a crosslinkable polymer TP-1-CI-0.8. To a 300 ml three-neck flask equipped with an overhead stirrer, TP-1-Neu (10 g), 1-bromo-6-chlorohexane (22.926 ml, 153.63 mmol) and dimethyl sulfoxide (150 ml) were added at room temperature and then the mixture was mixed at 800 rpm. The mixture turned transparent after 4 hours, and trifluoracetic acid (6.1 mmol) was added. Thereafter, the reaction continued at room temperature for 16 hours. The resulting transparent and yellow solution was added dropwise into a solution of sodium chloride to precipitate white to pale yellow pellets of TP-1-CI-0.8 resin. The resin was washed thoroughly with ethanol and DI water to remove solvent and chemical residues. Finally, the yellow resin product was filtered and dried completely at 80° C. in an oven. The yield of polymer is 96%. ¹H NMR (DMSO-d6, δ, ppm): 3.54 (H₉), 3.49 (H_{2′}), 3.42-3.35 (H₂ and H₄), 3.15 (H_{2″}), 3.08 (H₃), 2.90 (H₁), 2.78 (H_{1′}), 2.74 (H_{3″}), 2.37 (H_{1″}), 1.67, 1.66 (H₅ and H₈), 1.39 (H₆), and 1.25 (H₇). (FIG. 2). TP-1-CI-0.4 and TP-0.85-CI-0.6 can be synthesized following a similar procedure.

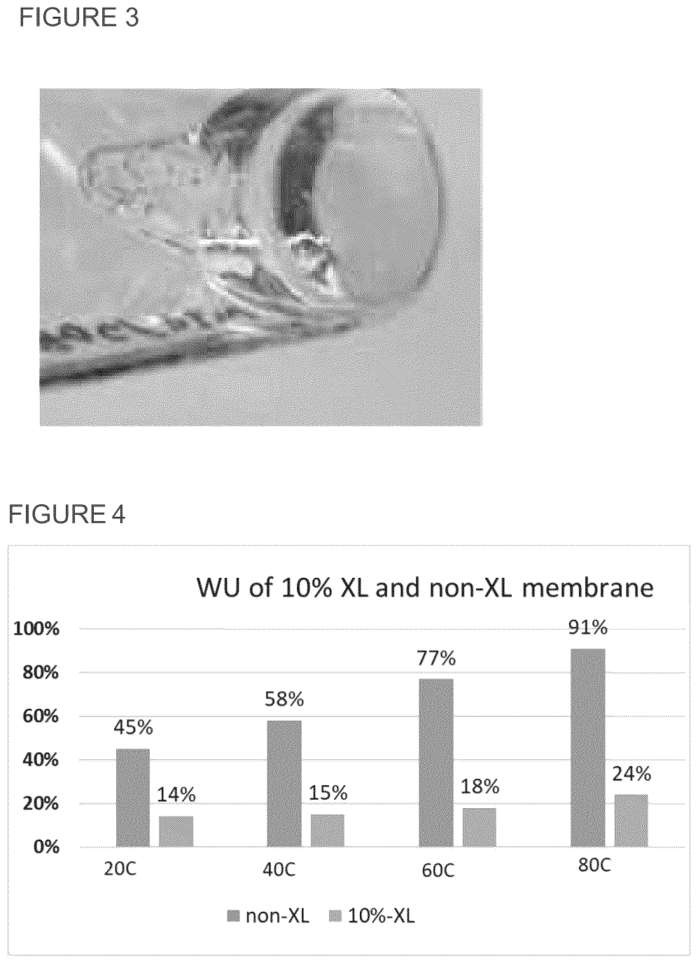

(2) Crosslinking of TP-1-CI-0.8 in an alkaline solution. 1 g of TP-1-CI-0.8 was first dissolved in 10 mL of DSMO and then a 4×4 inch membrane was cast with the solution at 80° C. This membrane was not crosslinked at this point. Then the membrane was immersed in 1M NaOH at 60° C. for 6-24 hours to finish the crosslinking (XL) of the membrane. Crosslinking degree was determined by a titration process, and it can be manipulated between 5% to 15% with the duration of soaking in the NaOH solution. FIG. 4 shows the 15% crosslinked (XL) membrane TP-1-XL-0.15 swells but not dissolves in DMSO as a sign of successful crosslinking. FIG. 5 shows that the TP-1-XL-0.15 membrane (bicarbonate form) had a much lower water uptake ratio than the non-XL membrane ((bicarbonate form)) in DI water from 20° C. to 80° C. Trimethylamine can be optionally added to quaternize all the unreacted Chloro groups in the crosslinked membrane to form TP-1-XL-0.15-TMA.

### Example 2

A crosslinkable polymer BP-n-CI-m and its crosslinked form was prepared from BP-n-Neu polymer (N is from 10 to 10000; n is from 0.1 to 1; m is from 0.1 to 1; x is from 0.1 to 1; y is from 0.1 to 1, z is from 0.01 to 0.1) was depicted in scheme 2. As an example, detailed preparation of BP-1-CI-0.33 (n=1, m=0.33) and its crosslinked membrane BP-1-CI-XL-0.24 (n=1, y=0.24) was described below.

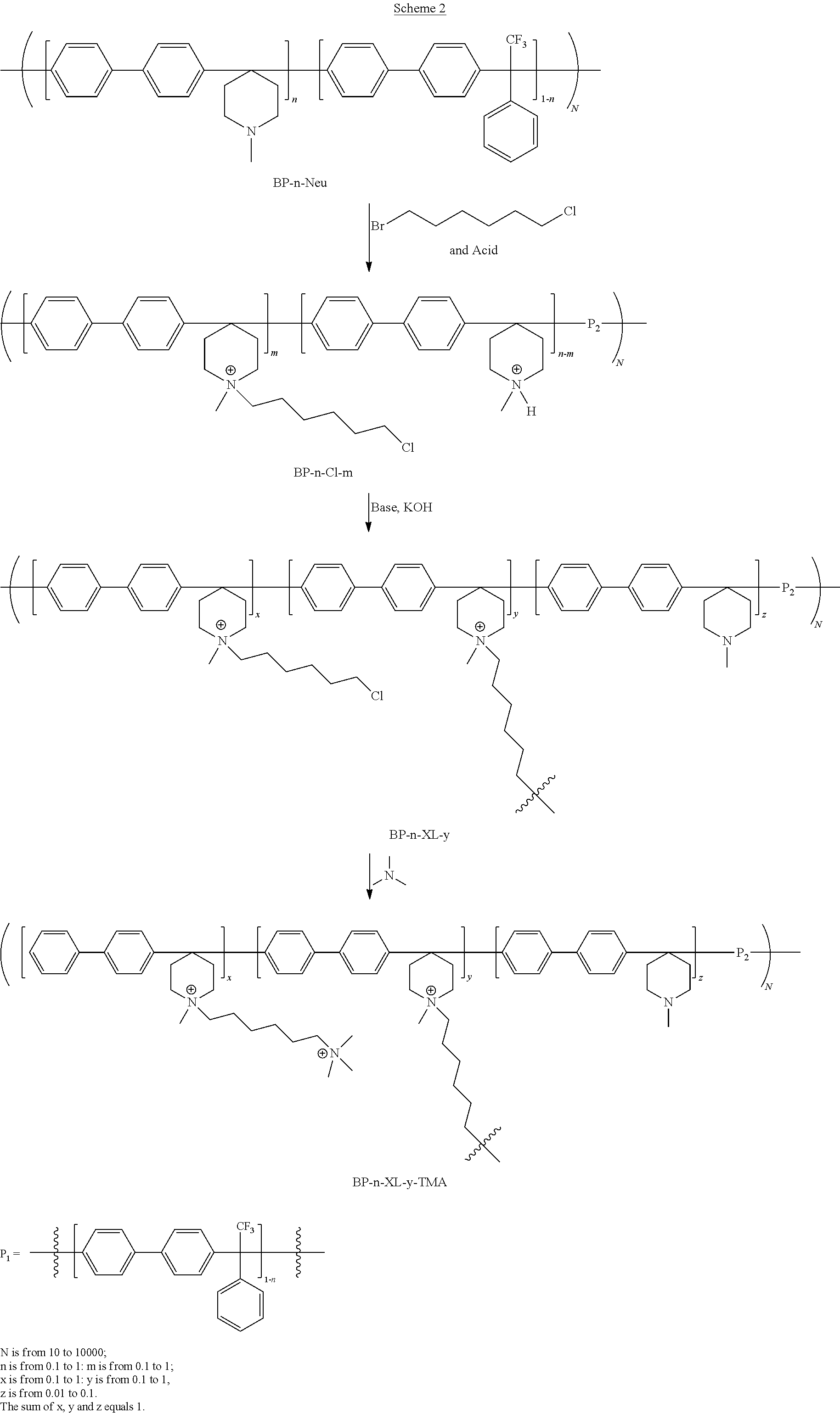

(1) Synthesis of a crosslinkable polymer BP-1-CI-0.33. To a 300 ml three-neck flask equipped with an overhead stirrer, BP-1-Neu (7 g), 1-bromo-6-chlorohexane (22.926 ml, 153.63 mmol) and dimethyl sulfoxide (150 ml) were added at room temperature and then the mixture was mixed at 800 rpm. The mixture turned transparent after 4 hours, and trifluoracetic acid (18 mmol) was added. Thereafter, the reaction continued at room temperature for 16 hours. The resulting transparent and yellow solution was added dropwise into a solution of sodium chloride to precipitate white to pale yellow pellets of BP-CI-0.33 resin. The resin was washed thoroughly with ethanol and DI water to remove solvent and chemical residues. Finally, the yellow resin product was filtered and dried completely at 80° C. in an oven. The yield of polymer is 91%. BP-1-CI-0.4, BP-0.3-CI-0.2 and BP-0.3-CI-0.4 can be synthesized following a similar procedure.

(2) Crosslinking of BP-1-CI-0.2 in an alkaline solution. 1 g of BP-1-CI-0.2 was first dissolved in 15 mL of DSMO and then a 4×4 inch membrane was cast with the solution at 80° C. This membrane was not crosslinked at this point. Then the membrane was immersed in 1M NaOH at 60° C. for 6-24 hours to finish the crosslinking (XL) of the membrane. Crosslinking degree was determined by a titration process, and it can be manipulated between 5% to 15% with the duration of soaking in the NaOH solution.

### Example 3

A crosslinkable polymer TP2-CI and its crosslinked form was prepared from TP2-Neu polymer (N is from 10 to 10000; a is from 0.1 to 0.95; b is from 0.01 to 0.9; c is from 0 to 0.9; d is from 0 to 0.9. The sum of a, b, c and d equals 1. e is from 0.01 to 0.95, x is from 0.01 to 0.95, y is from 0.01 to 0.90, z is from 0.01 to 0.50 and the sum of x, y and z is from 0.1 to 0.95) was depicted in scheme 3. Preparation of TP2-CI (a=0.7, b=0.1, c=0.1, d=0.1, e=0.33) and its crosslinked membrane was described briefly below.

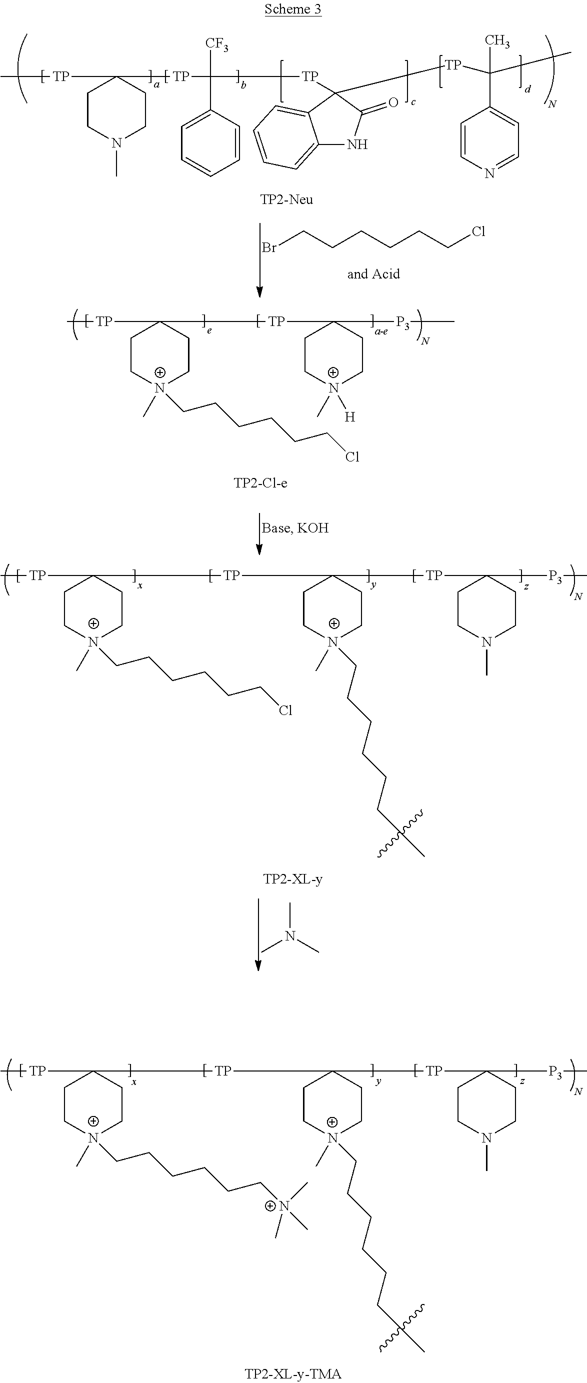

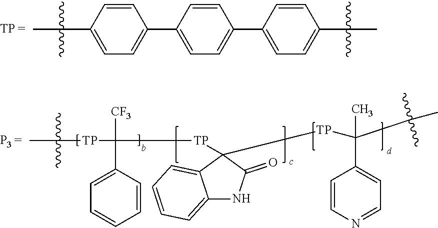

(1) Synthesis of a crosslinkable polymer TP2-CI (a=0.7. b=0.1. c=0.1, d=0.1, e=0.33). To a 300 ml three-neck flask equipped with an overhead stirrer, TP2-Neu (14 g), 1-bromo-6-chlorohexane (22.926 ml, 153.63 mmol) and dimethyl sulfoxide (150 ml) were added at room temperature and then the mixture was mixed at 800 rpm. The mixture turned transparent after 4 hours, and trifluoracetic acid (17.6 mmol) was added. Thereafter, the reaction continued at room temperature for 16 hours. The resulting transparent and yellow solution was added dropwise into a solution of sodium chloride to precipitate white to pale yellow pellets of TP2-CI resin. The resin was washed thoroughly with ethanol and DI water to remove solvent and chemical residues. Finally, the yellow resin product was filtered and dried completely at 80° C. in an oven. The yield of polymer is 94%.

(2) Crosslinking of TP2-CI in an alkaline solution. 1 g of TP2-CI was first dissolved in 12 mL of DSMO and then a 4×4 inch membrane was cast with the solution at 80° C. This membrane was not crosslinked at this point. Then the membrane was immersed in 1M NaOH at 60° C. for 6-24 hours to finish the crosslinking (XL) of the membrane. Crosslinking degree was determined by a titration process, and it can be manipulated between 5% to 25% with the duration of soaking in the NaOH solution.

### Example 4

A crosslinkable polymer BP2-CI and its crosslinked form was prepared from BP2-Neu polymer (N is from 10 to 10000; a is from 0.1 to 0.95; b is from 0.01 to 0.9; c is from 0 to 0.9; d is from 0 to 0.9. The sum of a, b, c and d equals 1. e is from 0.01 to 0.95, x is from 0.01 to 0.95, y is from 0.01 to 0.90, z is from 0.01 to 0.50 and the sum of x, y and z is from 0.1 to 0.95) was depicted in scheme 4. Preparation of BP2-CI (a=0.65, b=0.15, c=0.1, d=0.1, e=0.37) and its crosslinked membrane was described briefly below.

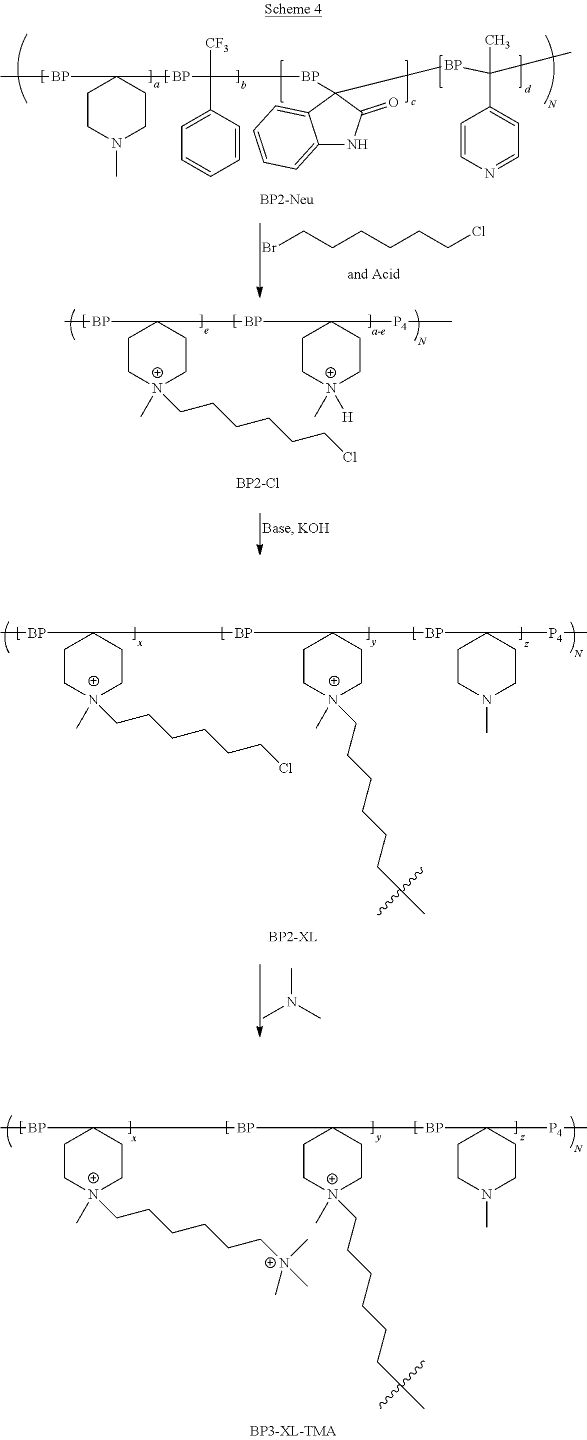

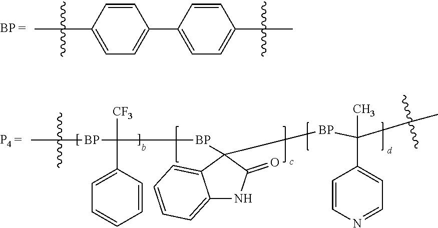

(1) Synthesis of a crosslinkable polymer BP2-CI (a=0.65, b=0.15, c=0.1, d=0.1, e=0.37). To a 300 ml three-neck flask equipped with an overhead stirrer, BP2-Neu (8 g), 1-bromo-6-chlorohexane (22.926 ml, 153.63 mmol) and dimethyl sulfoxide (150 ml) were added at room temperature and then the mixture was mixed at 800 rpm. The mixture turned transparent after 4 hours, and trifluoracetic acid (13 mmol) was added. Thereafter, the reaction continued at room temperature for 16 hours. The resulting transparent and yellow solution was added dropwise into a solution of sodium chloride to precipitate white to pale yellow pellets of BP2-CI resin. The resin was washed thoroughly with ethanol and DI water to remove solvent and chemical residues. Finally, the yellow resin product was filtered and dried completely at 80° C. in an oven. The yield of polymer is 83%.

(2) Crosslinking of BP2-CI in an alkaline solution. 1 g of BP2-CI was first dissolved in 8 mL of DSMO and then a 4×4 inch membrane was cast with the solution at 80° C. This membrane was not crosslinked at this point. Then the membrane was immersed in 1M NaOH at 60° C. for 6-24 hours to finish the crosslinking (XL) of the membrane. Crosslinking degree was determined by a titration process, and it can be manipulated between 5% to 32% with the duration of soaking in the NaOH solution.

### Example 5

A crosslinkable polymer BPTP-CI and its crosslinked form was prepared from BPTP-Neu polymer (N is from 10 to 10000; m, n, p and k are respectively, from 0.01 to 0.99, and the sum of m, n, p and k equals 1. a, b, c, d are respectively from 0.01 to 0.99, and the sum of a, b equals to m. the sum of a, b equals to n. x, y, z, t, r and s are respectively from 0.01 to 0.99, and the sum of x, y equals to a. the sum of y, z equals to b; the sum of t, r equals to b; the sum of r, s equals to d). Preparation of BPTP-CI (m=0.4, n=0.4, p=0.1, k=0.1, a+c=0.27) and and its crosslinked membrane was described briefly below.

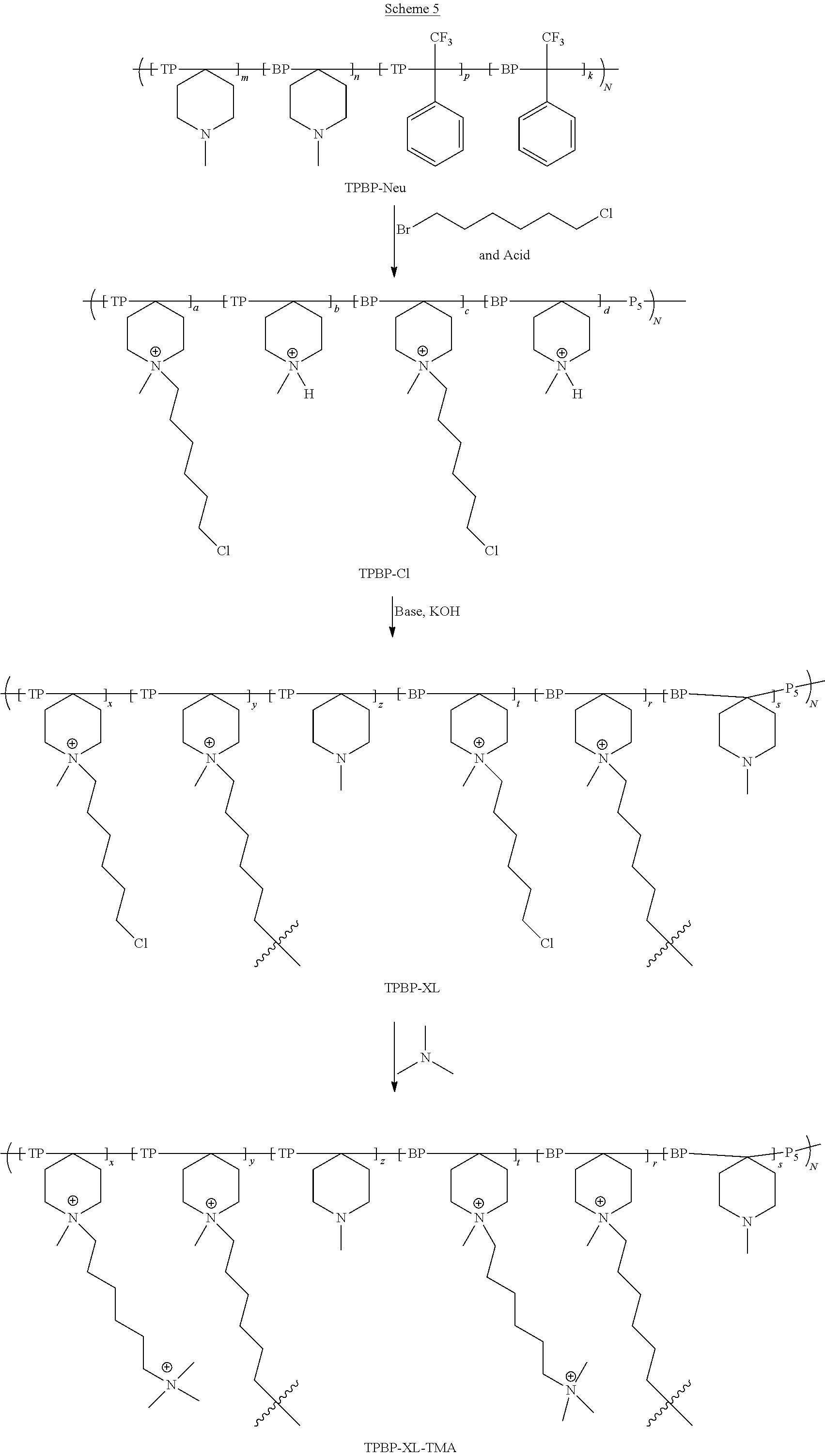

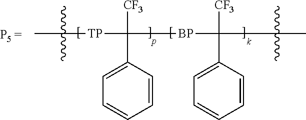

(1) Synthesis of a crosslinkable polymer TPBP-CI (m=0.4, n=0.4, p=0.1, k=0.1. a+c=0.27). To a 300 ml three-neck flask equipped with an overhead stirrer, TPBP-Neu (9 g), 1-bromo-6-chlorohexane (22.926 ml, 153.63 mmol) and dimethyl sulfoxide (150 ml) were added at room temperature and then the mixture was mixed at 800 rpm. The mixture turned transparent after 4 hours, and trifluoracetic acid (17 mmol) was added. Thereafter, the reaction continued at room temperature for 16 hours. The resulting transparent and yellow solution was added dropwise into a solution of sodium chloride to precipitate white to pale yellow pellets of TPBP-CI resin. The resin was washed thoroughly with ethanol and DI water to remove solvent and chemical residues. Finally, the yellow resin product was filtered and dried completely at 80° C. in an oven. The yield of polymer is 87%.

(2) Crosslinking of TPBP-CI in an alkaline solution. 1 g of TPBP-CI was first dissolved in 10 mL of DSMO and then a 4×4 inch membrane was cast with the solution at 80° C. This membrane was not crosslinked at this point. Then the membrane was immersed in 1M NaOH at 60° C. for 6-24 hours to finish the crosslinking (XL) of the membrane. Crosslinking degree was determined by a titration process, and it can be manipulated between 5% to 21% with the duration of soaking in the NaOH solution.

### Definitions

The term “suitable substituent,” as used herein, is intended to mean a chemically acceptable functional group, preferably a moiety that does not negate the activity of the inventive compounds. Such suitable substituents include, but are not limited to halo groups, perfluoroalkyl groups, perfluoroalkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxycarbonyl groups, alkylsulfonyl groups, and arylsulfonyl groups. Those skilled in the art will appreciate that many substituents can be substituted by additional substituents.

The term “alkyl,” as used herein, refers to a linear, branched or cyclic hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons), and more preferably having 1 to 18 carbon atoms. Alkyl groups include, but are not limited to, methyl, ethyl, n-propyl, isopropyl, n-butyl, iso-butyl, secondary-butyl, and tertiary-butyl. Alkyl groups can be unsubstituted or substituted by one or more suitable substituents.

The term “alkenyl,” as used herein, refers to a straight, branched or cyclic hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, more preferably having 1 to 18 carbon atoms, and having one or more carbon-carbon double bonds. Alkenyl groups include, but are not limited to, ethenyl, 1-propenyl, 2-propenyl (allyl), iso-propenyl, 2-methyl-1-propenyl, 1-butenyl, and 2-butenyl. Alkenyl groups can be unsubstituted or substituted by one or more suitable substituents, as defined above.

The term “alkynyl,” as used herein, refers to a straight, branched or cyclic hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, more preferably having 1 to 18 carbon atoms, and having one or more carbon-carbon triple bonds. Alkynyl groups include, but are not limited to, ethynyl, propynyl, and butynyl. Alkynyl groups can be unsubstituted or substituted by one or more suitable substituents, as defined above.

The term “aryl” or “ar,” as used herein alone or as part of another group (e.g., aralkyl), means monocyclic, bicyclic, or tricyclic aromatic radicals such as phenyl, naphthyl, tetrahydronaphthyl, indanyl and the like; optionally substituted by one or more suitable substituents, preferably 1 to 5 suitable substituents, as defined above. The term “aryl” also includes heteroaryl.

“Arylalkyl” or “aralkyl” means an aryl group attached to the parent molecule through an alkylene group. The number of carbon atoms in the aryl group and the alkylene group is selected such that there is a total of about 6 to about 18 carbon atoms in the arylalkyl group. A preferred arylalkyl group is benzyl.

The term “cycloalkyl,” as used herein, refers to a mono, bicyclic or tricyclic carbocyclic radical (e.g., cyclopropyl, cyclobutyl, cyclopentyl, cyclohexyl, cycloheptyl, cyclooctyl, cyclononyl, cyclopentenyl, cyclohexenyl, bicyclo[2.2.1]heptanyl, bicyclo[3.2.1]octanyl and bicyclo[5.2.0]nonanyl, etc.); optionally containing 1 or 2 double bonds. Cycloalkyl groups can be unsubstituted or substituted by one or more suitable substituents, preferably 1 to 5 suitable substituents, as defined above.

The term “-ene” as used as a suffix as part of another group denotes a bivalent radical in which a hydrogen atom is removed from each of two terminal carbons of the group, or if the group is cyclic, from each of two different carbon atoms in the ring. For example, alkylene denotes a bivalent alkyl group such as ethylene (˜CH2CH2-) or isopropylene (—CH(CH3)CH2-). For clarity, addition of the -ene suffix is not intended to alter the definition of the principal word other than denoting a bivalent radical. Thus, continuing the example above, alkylene denotes an optionally substituted linear saturated bivalent hydrocarbon radical.

The term “hydrocarbon” as used herein describes a compound or radical consisting exclusively of the elements carbon and hydrogen.

The term “polycycle” as used herein describes a compound or radical having two or more hydrocarbon rings which can be substituted with heteroatom(s) such as nitrogen or oxygen. The polycycle can be aromatic or non-aromatic.

The term “substituted” means that in the group in question, at least one hydrogen atom bound to a carbon atom is replaced with one or more substituent groups such as hydroxy (—OH), alkylthio, phosphino, amido (—CON(RA)(RB), wherein RA and RB are independently hydrogen, alkyl, or aryl), amino (—N(RA)(RB), wherein RA and RB are independently hydrogen, alkyl, or aryl), halo (fluoro, chloro, bromo, or iodo), silyl, nitro (—NO2), an ether (-ORA wherein RA is alkyl or aryl), an ester (—OC(O) RA wherein RA is alkyl or aryl), keto (—C(O) RA wherein RA is alkyl or aryl), heterocyclo, and the like. When the term “substituted” introduces or follows a list of possible substituted groups, it is intended that the term apply to every member of that group. That is, the phrase “optionally substituted alkyl or aryl” is to be interpreted as “optionally substituted alkyl or optionally substituted aryl.” Likewise, the phrase “alkyl or aryl optionally substituted with fluoride” is to be interpreted as “alkyl optionally substituted with fluoride or aryl optionally substituted with fluoride.”

The term “tethered” means that the group in question is bound to the specified polymer backbone. For example, an imidazolium-tethered poly (aryl alkylene) polymer is a polymer having imidazolium groups bound to a poly (aryl alkylene) polymer backbone.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved, and other advantageous results attained.

As various changes could be made in the above products and methods without departing from the scope of the invention, it is intended that all matter contained in the above description and shown in the accompanying drawings shall be interpreted as illustrative and not in a limiting sense.

1. A crosslinkable anion exchange polymer comprising:
structural units of formulae 1A, 1A-2, 3A, optionally 2A and optionally 6A wherein a sum of mole fractions of the structural units of formulae 1A, 1A-2, 2A and 6A is equal to a sum of a mole fraction of formulae 3A in the polymer calculated from an amount of monomers used in a polymerization reaction to form the polymer, and a mole ratio of the structural unit of Formula 1A or 1A-2 or 2A or 6A to the structural unit of Formula 3A is from 0.01 to 1 calculated from the amount of monomers used in the polymerization reaction; or
structural units of formulae 1A, 1A-2, 3A, 4A, optionally 2A and optionally 6A wherein a sum of mole fractions of the structural units of formulae 1A, 1A-2, 2A, 4A and 6A is equal to a sum of a mole fraction of formula 3A in the polymer calculated from an amount of monomers used in a polymerization reaction to form the polymer, and a mole ratio of the structural unit of Formula 1A or 1A-2 or 2A or 4A or 6A to the structural unit of Formula 3A is from 0.01 to 1 calculated from the amount of monomers used in the polymerization reaction; and
the structural units of Formulae 1A, 1A-2, 2A, 3A, 4A and 6A have the structures: 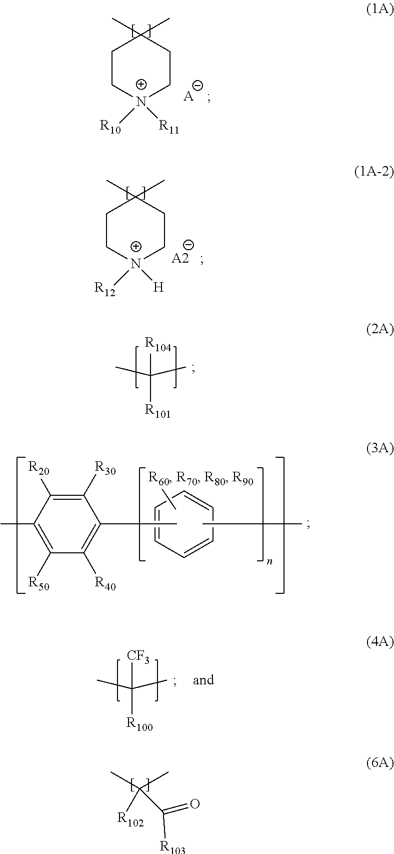
wherein:
A⁻ and A₂⁻ are each independently an anion;
L is Cl, Br or I;
n are each independently 0, 1, 2 or 3;
q is 0, 1, 2, 3, 4, 5 or 6;
R₁₀ and R₁₂ are each independently, alkyl, alkenyl, alkynyl or aryl;
R₁₁ is each independently halide substituted alkyl, alkenyl, alkynyl, aryl, or 5A having structure: 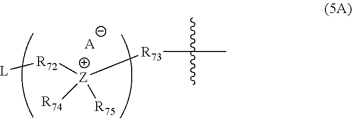
R₂₀, R₂₁, R₂₂, R₂₃, R₂₄, R₂₅, R₂₆, R₂₇, R₂₈, R₂₉, R₃₀, R₄₀, R₅₀, R₆₀, R₇₀, R₈₀, R₉₀, R₁₀₄, R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide; wherein R₃₀ and R₆₀ are optionally linked to form a five membered ring optionally substituted with halide or alkyl;
R₇₂, R₇₃, R₇₄ and R₇₅ are each independently alkyl, alkenyl, alkynyl or aryl;
R₁₀₀ is each independently alkyl, alkenyl, alkynyl, or 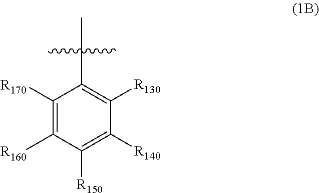
and the alkyl, alkenyl, or alkynyl are optionally substituted with fluoride;
each R₁₀₁ is independently 2B or 3B having structure: 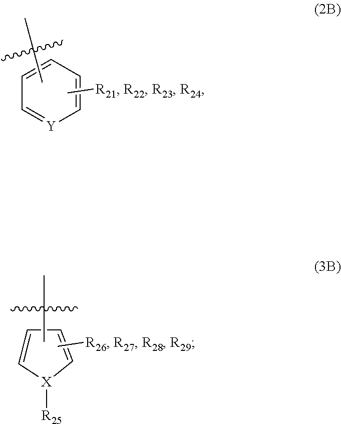
R₁₀₂ and R₁₀₃ are each independently alkyl, alkenyl, alkynyl, amine or aryl, and the alkyl, alkenyl, alkynyl, amine or aryl are optionally substituted with halide or alkyl, and wherein R₁₀₂ and R₁₀₃ are optionally linked to form a five or six membered ring or a polycycle;
X is N, S or O;
Y is C or N; and
Z is N or P.

2. A polymer comprising a reaction product of a mixture comprising:
an acid, a reagent having formula 5 and a polymer comprising structural units of formulae 1, 3A, optionally 1A-3, optionally 2A, and optionally 6A wherein a sum of mole fractions of the structural units of formulae 1, 2A, 1A-3 and 6A is equal to a sum of a mole fraction of formula 3A in the polymer calculated from an amount of monomers used in a polymerization reaction to form the polymer, and a mole ratio of the structural unit of Formula 1 or 1A-3 or 2A or 6A to the structural unit of Formula 3A is from 0.01 to 1 calculated from the amount of monomers used in the polymerization reaction, and a mole ratio of the acid or reagent of formula 5 to the structural unit of formula 1 in the polymer is from 0.01 to 0.99; or
an acid, a reagent having formula 5 and a polymer comprising structural units of formulae 1, 3A, 4A, optionally 1A-3, optionally 2A, and optionally 6A wherein a sum of mole fractions of the structural units of formulae 1, 1A-3, 2A, 4A and 6A is equal to a sum of a mole fraction of formula 3A in the polymer calculated from an amount of monomers used in a polymerization reaction to form the polymer, and a mole ratio of the structural unit of Formula 1 or 1A-3 or 2A or 4A or 6A to the structural unit of Formula 3A is from 0.01 to 1 calculated from the amount of monomers used in the polymerization reaction, and a mole ratio of the acid or reagent of formula 5 to the structural unit of formula 1 in the polymer is from 0.01 to 0.99; and
the structural units of Formulae 1, 1A-3, 2A, 3A, 4A, 5 and 6A have the structures: 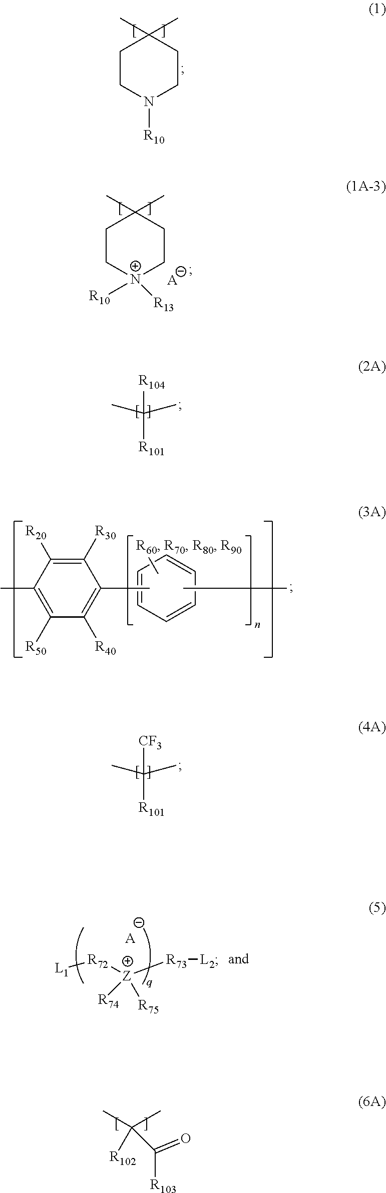
wherein:
A⁻ is an anion;
n are each independently 0, 1, 2 or 3;
q is 0, 1, 2, 3, 4, 5 or 6;
L₁ and L₂ are each independently Cl, Br, I, a tosylate, a mesylate, or a triflate;
R₁₀ is independently alkyl, alkenyl, alkynyl or aryl;
R₁₃ is independently hydrogen, alkyl, alkenyl, alkynyl or aryl;
R₂₀, R₂₁, R₂₂, R₂₃, R₂₄, R₂₅, R₂₆, R₂₇, R₂₈, R₂₉, R₃₀, R₄₀, R₅₀, R₆₀, R₇₀, Rao, R₉₀, R₁₀₄, R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide; wherein R₃₀ and R₆₀ are optionally linked to form a five membered ring optionally substituted with halide or alkyl;
R₇₂, R₇₃, R₇₄ and R₇₅ are each independently alkyl, alkenyl, alkynyl or aryl;
each R₁₀₀ is independently alkyl, alkenyl, alkynyl, or 1B having structure: 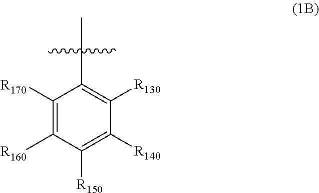
and the alkyl, alkenyl, or alkynyl are optionally substituted with fluoride;
each R₁₀₁ is independently 2B or 3B having structure: 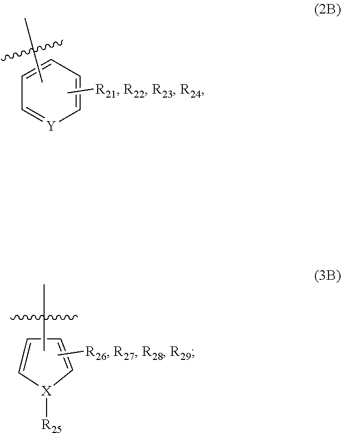
R₁₀₂ and R₁₀₃ are each independently alkyl, alkenyl, alkynyl, amine or aryl, and the alkyl, alkenyl, alkynyl, amine or aryl are optionally substituted with halide or alkyl, and wherein R₁₀₂ and R₁₀₃ are optionally linked to form a five or six membered ring or a polycycle;
X is N, S or O;
Y is C or N; and
Z is N or P.

3. The polymer of claim 1, wherein;
the mole ratio of a sum of the mole fractions of the structural unit of Formulae 1A, 1A-2, 2A and 6A to the mole fraction of Formula 3A in the polymer is from about 0.85:1 to about 1.4:1, and the ratio of the mole fraction of the structural unit of Formula 1A to the mole fraction of the structural unit of Formula 3A is from about 0.01 to 0.99; or
the mole ratio of a sum of the mole fractions of the structural unit of Formula 1A, 1A-2, 2A and 6A to the mole fraction of Formula 3A in the polymer is from about 1:1 to about 1.2:1; or
the mole ratio of a sum of the mole fractions of the structural unit of Formula 1A, 1A-2, 2A, 4A and 6A to the mole fraction of Formula 3A in the polymer is from about 0.85:1 to about 1.4:1, and the ratio of the mole fraction of the structural unit of Formula 1A to the mole fraction of the structural unit of Formula 3A is from about 0.01 to 0.99; or
the mole ratio of a sum of the mole fractions of the structural unit of Formulae 1A, 1A-2, 2A, 4A and 6A to the mole fraction of Formula 3A in the polymer is from about 1:1 to about 1.2:1.

4.-6. (canceled)

7. The polymer of claim 2, wherein:
the mixture comprising structural units of formulae 1, 3A, optionally 1A-3, optionally 2A, and optionally 6A, wherein; the mole ratio of a sum of the mole fractions of the structural unit of Formulae 1, 2A, 1A-3 and 6A to a mole fraction of formula 3A in the polymer is from about 0.85:1 to about 1.4:1, and the ratio of the mole fraction of the structural unit of Formula 1 to the mole fraction of the structural unit of Formula 3A is from about 0.01 to 0.99; or the mole ratio of the sum of the mole fractions of the structural units of formulae 1, 2A, 1A-3 and 6A to the mole fraction of formula 3A in the polymer is from about 1:1 to about 1.2:1; or
the mixture comprising structural units of formulae 1, 3A, 4A, optionally 1A-3, optionally 2A, and optionally 6A, wherein: the mole ratio of a sum of the mole fractions of the structural unit of Formulae 1, 2A, 1A-3, 4A and 6A to a sum of the mole fraction of formula 3A in the polymer is from about 0.85:1 to about 1.4:1, and the ratio of the mole fraction of the structural unit of Formula 1 to the mole fraction of the structural unit of Formula 3A is from about 0.01 to 0.99; or the mole ratio of the sum of the mole fractions of the structural units of formulae 1, 2A, 1A-3, 4A and 6A to the sum of the mole fraction of formula 3A in the polymer is from about 1:1 to about 1.2:1.

8.-10. (canceled)

11. The polymer of claim 2, wherein the acid comprises hydrochloric acid, hydrobromic acid, hydriodic acid, sulfuric acid, nitric acid, trifluoracetic acid, acetic acid, butyric acid, formic acid, trifluoromethanesulfonic acid or a combination thereof.

12. The polymer of claim 2, wherein:
in the reagent of formula 5, A⁻ is an anion; L₁ and L₂ are each independently Cl, Br, I, a tosylate, a mesylate, or a triflate; q is 0, 1, 2, 3, 4, 5, or 6; R₇₂, R₇₄ and R₇₅ are each independently C₁-C₆ alkyl; R₇₃ is independently C₁-C₂₂ alkylene; and Z is N or P; or
the reagent of formula 5 comprises 1-Bromo-6-chlorohexane, 1-chloro-6-iodoohexane, 1-bromo-6-iodoohexane, 1-Bromo-4-chlorobutane, 1-Chloro-4-iodobutane, 1-Bromo-4-chlorobutane, 1-Bromo-3-chloropropane, 1-Chloro-3-iodopropane, 1-Bromo-3-iodopropane, and preferably Reagent 5 is 1-Bromo-6-chlorohexane, 1-chloro-6-iodoohexane, 1-bromo-6-iodoohexane, 1-Bromo-4-chlorobutane, 1-Chloro-4-iodobutane, 1-Bromo-4-chlorobutane, 6-chlorohexyl methanesulfonate, 6-bromohexyl methanesulfonate, or a combination thereof.

13. (canceled)

14. The polymer of claim 1, wherein R₁₀ and R₁₂ of the structural units of formulae 1, 1A, 1A-2 and 1A-3 are each independently alkyl, alkenyl, alkynyl or aryl; or R₁₀ and R₁₂ of the structural units of formulae 1, 1A, 1A-2 and 1A-3 are each independently C₁-C₂₂ alkyl; or R₁₀ and R₁₂ of the structural units of formulae 1, 1A, 1A-2 and 1A-3 are each independently methyl, ethyl, n-propyl, n-butyl, isobutyl, tert-butyl, pentyl or hexyl.

15. The polymer of claim 1, wherein:
R₁₁ of formula 1A is each independently halide substituted alkyl, alkenyl, alkynyl, aryl, or formula 5A having structure: 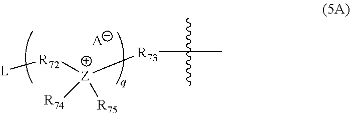
wherein A⁻ is an anion; L is Cl, Br or I; q is 0, 1, 2, 3, 4, 5, or 6; R₇₂, R₇₄ and R₇₅ are each independently C₁-C₆ alkyl; R₇₃ is independently C₁-C₂₂ alkylene; and Z is N or P; or
R₁₁ of formula 1A is each independently halide substituted alkyl, alkenyl, alkynyl, aryl, or formula 5A having structure: 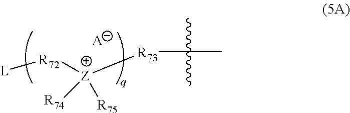
wherein A⁻ is an anion; L is Cl; g is 0, 1, 2, 3; R₇₂, R₇₄ and R₇₅ are each independently C₁-C₆ alkyl; R₇₃ is independently C₁-C₆ alkylene; and Z is N; or
R₁₁ of formula 1A is:

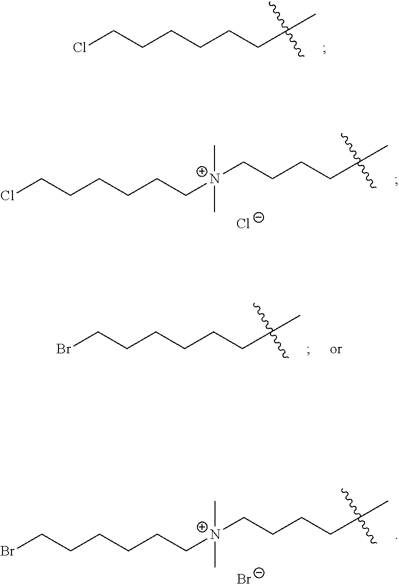 [SMILES: *CCCCCCCl ; *CCCC[N+](C)(C)CCCCCCCl ; [Cl-] ; *CCCCCCBr ; *CCCC[N+](C)(C)CCCCCCBr ; [Br-]]

16.-17. (canceled)

18. The polymer of claim 2, wherein R₁₃ of formula 1A-3 comprises hydrogen, C₁-C₂₂ alkyl, C₁-C₂₂ alkenyl, C₁-C₂₂ alkynyl or aryl.

19. The polymer of claim 1, wherein the structural unit of formula 3A comprises 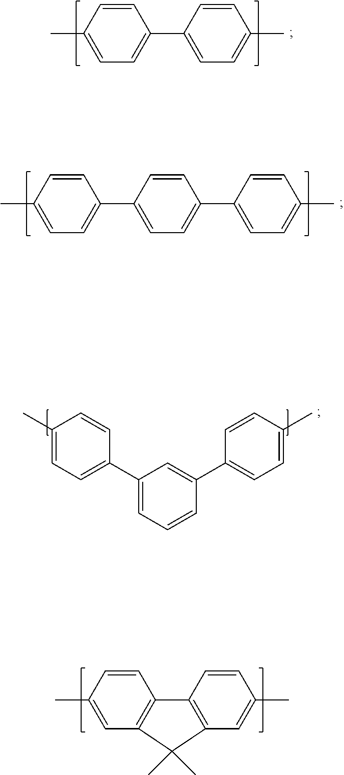
or a combination thereof.

20. The polymer of claim 1, wherein the structural unit of formula 6A comprises 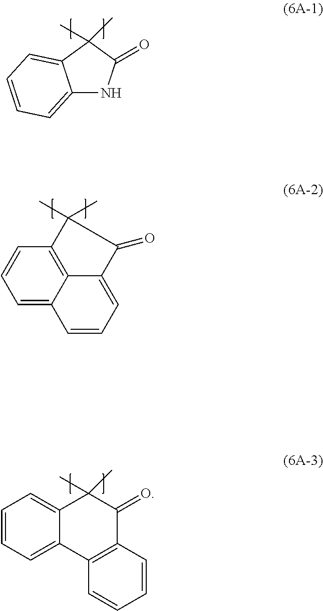
or a combination thereof.

21. The polymer of claim 1, wherein A⁻ and/or A₂⁻ is an anion comprising a halide, carbonate, bicarbonate, hydroxide, trifluoroacetate, acetate, triflate, methanesulfonate, sulfate, nitrate, tetrafluoroborate, hexafluorophosphate, formate, benzenesulfonate, toluate, perchlorate, benzoate or a combination thereof.

22. A method of making a crosslinked anion exchange polymer comprising:
(i) reacting a reagent of formula 5, optionally an acid, and a polymer comprising structural units of formulae 1, 3A, optionally 1A-3, optionally 2A and optionally 6A or structural units of formulae 1, 3A, 4A, optionally 1A-3, optionally 2A and optionally 6A to form the crosslinkable polymer of any one of claims 1, 3-6, 14-17 and 19-21;
precipitating the crosslinkable polymer;
rinsing and drying the crosslinkable polymer;
mixing the crosslinkable polymer and a base capable of initiating crosslinking while controlling reaction temperature and reaction time to obtain a crosslinked polymer having about 1 to 100% crosslinking;
and optionally exchanging anions of the crosslinked polymer with hydroxide, bicarbonate, or carbonate ions or a combination thereof to form a crosslinked anion exchange polymer; or
(ii) reacting a reagent of formula 5, optionally an acid, and a polymer comprising structural units of formulae 1, 3A, optionally 1A-3, optionally 2A and optionally 6A or structural units of formulae 1, 3A, 4A, optionally 1A-3, optionally 2A and optionally 6A to form the crosslinkable polymer of any one of claims 1, 3-6, 14-17 and 19-21;
precipitating the crosslinkable polymer;
rinsing and drying the crosslinkable polymer;
dissolving the crosslinkable polymer in a solvent to form a polymer solution;
casting a crosslinkable membrane from the polymer solution;
mixing the crosslinkable membrane and a base capable of initiating crosslinking while controlling reaction temperature and reaction time to obtain a crosslinked membrane having about 1 to 100% crosslinking; and
optionally exchanging anions of the crosslinked membrane with hydroxide, bicarbonate, or carbonate ions or a combination thereof to form a crosslinked anion exchange membrane.

23. (canceled)

24. A method of making a membrane electrode assembly (MEA) with crosslinked ionomer comprising:
reacting a reagent of formula 5, optionally an acid, and a polymer comprising structural units of formulae 1, 3A, optionally 1A-3, optionally 2A and optionally 6A or structural units of formulae 1, 3A, 4A, optionally 1A-3, optionally 2A and optionally 6A to form the crosslinkable polymer of any one of claims 1, 3-6, 14-17 and 19-21;
precipitating the crosslinkable polymer;
rinsing and drying the crosslinkable polymer;
dissolving the crosslinkable polymer in a solvent to form a polymer suspension;
mixing the polymer suspension with a catalyst to form a catalyst ink;
applying the catalyst ink to a membrane to form a MEA;
drying the MEA;
mixing the MEA and a base capable of initiating crosslinking while controlling reaction temperature and reaction time to obtain a crosslinked MEA having about 1 to 100% crosslinking; and
optionally exchanging anions of the crosslinked MEA with hydroxide, bicarbonate, or carbonate ions or a combination thereof to form the MEA with crosslinked ionomer.

25. The method of claim 22, wherein;
the solvent comprises methanol, ethanol, n-propanol, isopropanol, n-butanol, sec-butanol, tert-butanol, a pentanol, a hexanol, dimethyl sulfoxide, 1-methyl-2-pyrrolidone, dimethylformamide, dimethyl sulfoxide, dimethylacetamide, chloroform, ethyl lactate, tetrahydrofuran, N-Methyl-2-pyrrolidone, 2-methyltetrahydrofuran, water, phenol, acetone, or a combination thereof; or
the base comprises a solution or suspension of KOH, NaOH, NaHCO₃, KHCO₃, Na₂CO3, K₂CO₃ or a combination thereof; or
the crosslinked polymer, the crosslinked membrane or the crosslinked MEA has about 2% to about 75%, about 3% to about 50%, about 4% to about 40%, about 5% to about 35%, about 5% to about 30%, about 5% to about 25%, about 5% to about 20% or about 5% to about 15% crosslinking.

26.-27. (canceled)

28. An anion exchange membrane configured and sized to be suitable for use in a fuel cell, electrolyzer, electrodialyzer, solar hydrogen generator, flow battery, desalinator, sensor, demineralization of water, ultra-pure water production, wastewater treatment, ion exchanger, or CO₂ separator, and comprising the polymer of claim 1.

29. An anion exchange membrane fuel cell, electrolyzer, electrodialyzer, solar hydrogen generator, flow battery, desalinator, sensor, demineralization of water, ultra-pure water production, wastewater treatment, ion exchanger, or CO₂ separator comprising the polymer of claim 1.

30. A reinforced ion exchange membrane or electrolyte membrane, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO2 separator, the reinforced membrane comprising a porous substrate impregnated with the polymer of claim 1.

31. The membrane of claim 30, wherein the porous substrate comprises polytetrafluoroethylene, polypropylene, polyethylene, poly(ether) ketone, polyaryletherketone, imidazole-tethered poly(aryl alkylene), imidazolium-tethered poly(aryl alkylene), polysulfone, perfluoroalkoxyalkane, or a fluorinated ethylene propylene polymer, and the membrane is optionally a dimensionally stable membrane.

32. The membrane of claim 30, wherein either:
the porous substrate has a porous microstructure of polymeric fibrils;
an interior volume of the porous substrate is rendered substantially occlusive by impregnation with the polymer;
the porous substrate comprises a microstructure of nodes interconnected by fibrils;
the porous substrate has a thickness from about 1 micron to about 100 microns;
the membrane is prepared by multiple impregnations of the substrate with the polymer; or
the membrane is prepared by:
wetting the porous substrate in a liquid to form a wetted substrate;
dissolving the polymer in a solvent to form a homogeneous solution or suspension;
applying the solution or suspension onto the wetted substrate to form the reinforced membrane; and
drying the membrane.
